(19) United States
(12) Patent Application Publication
(10) Pub. No.: US 2017/0142369 A1
(43) Pub. Date: May 18, 2017

(54) INTERACTIVE ELECTRONIC WHITEBOARD WITH VIDEO COMMUNICATION FUNCTION

(71) Applicant: Hong Ting Tsai, San Diego, CA (US)

(72) Inventor: Ming Tang TSAI, Suzhou (CN)

(73) Assignee: Hong Ting Tsai, San Diego, CA (US)

(21) Appl. No.: 15/353,109

(22) Filed: Nov. 16, 2016

(30) Foreign Application Priority Data
Nov. 17, 2015 (CN) 201510790673.6

(51) Int. Cl. H04N 7/15; G06F 3/042; G06K 9/00; H04N 7/14

(52) U.S. Cl. CPC H04N 7/15; H04N 7/142; G06F 3/042; G06K 9/00013

(57) ABSTRACT

An interactive electronic whiteboard with video communication function is disclosed, including an electronic whiteboard body, a master control board is embedded in the framework of the electronic whiteboard body, computer or tablet PC or mobile phone connected to electronic whiteboard body, as well as a camera mounted in the upper frame of framework of the electronic whiteboard body. The camera has an optical lens, an optical sensor and a control transmission chip connected in turn. The optical sensor is connected to computer or tablet PC or mobile phone via control transmission chip. The camera provides video communication function, solving the problem in the present electronic whiteboard which cannot implement visual communication.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an electronic whiteboard, and more particularly to an interactive electronic whiteboard with video communication function.

2. Description of Related Art Including Information Disclosed Under 37 CFR 1.97 and 37 CFR 1.98.

In a Chinese patent for invention, published application No. CN104156124A, date of published application Nov. 19, 2014, an infrared electronic whiteboard is disclosed, including a frame plate, there is a writing board in the center of frame plate, a transparent liquid crystal strip surrounding the writing board is located on the frame plate, an infrared transmitting tube and an infrared receiving tube are located along the side of writing board on the frame plate. The invention will not implement wrong positioning when external interference occurs, facilitating the use of electronic whiteboard greatly. But the electronic whiteboard cannot implement the video communication function, and as such the communication cannot be visualized.

### BRIEF SUMMARY OF THE INVENTION

In order to overcome the aforesaid defect, the present invention aims to provide an interactive electronic whiteboard with video communication function for visual communication via an electronic whiteboard.

In order to attain the aforesaid goal, the technical proposal adopted by the present invention is an interactive electronic whiteboard with video communication function, which comprises an electronic whiteboard body, the master control board is embedded in the framework of said electronic whiteboard body, a computer or a tablet PC or a mobile phone connected to the electronic whiteboard body, as well as a camera. Said camera is located in the upper frame of framework of electronic whiteboard body. Said camera comprises an optical lens, an optical sensor and a control transmission chip which are connected in turn. Said optical sensor is connected to the computer or tablet PC or mobile phone via the control transmission chip. The camera enables the persons in two meeting rooms to perform video communication function. The optical lens captures images, the optical sensor converts the captured image signal into data signal, which is transferred by the control transmission chip to the first computer or tablet PC or mobile phone connected to the electronic whiteboard. The first computer or tablet PC or mobile phone transfers the image data via network to the second computer or tablet PC or mobile phone connected to another electronic whiteboard, so as to implement visual video communication function on two electronic whiteboards.

As a further improvement of the present invention, a USB HUB multi-interface sharer is located in the framework of said infrared touch electronic whiteboard body. Said USB HUB multi-interface sharer is connected to the master control board. The output of the equipment for multi-USB transmission is implemented via one outlet, the flat cables are reduced.

As a further improvement of the present invention, said USB HUB multi-interface sharer is located in the lower part of one side of electronic whiteboard body for convenient use.

As a further improvement of the present invention, said electronic whiteboard body uses infrared electronic touchpad. Said electronic touch whiteboard comprises at least two infrared cameras and optical reflection strip. Said at least two infrared cameras are located in the framework corners of electronic whiteboard body. Said optical reflection strip is mounted on the four edges of framework of electronic whiteboard body. Each infrared camera contains a LED light source. Said LED light source irradiates the opposite optical reflection strip. The infrared camera embedded with the LED light source receives the reflected light. Two adjacent infrared cameras transmit the observed signal to the master control board. Said master control board calculates the data of touch point on the optical reflection strip to obtain the touch coordinates. The touch point tracking is implemented by infrared camera and optical reflection strip, accurate and reliable. The application of at least two infrared cameras can implement touch control of at least one point. When three infrared cameras are used, the simultaneous touch control of two points can be implemented. When four infrared cameras are used, the simultaneous touch control of three points can be implemented.

As a further improvement of the present invention, an audio expander is embedded in the framework of said electronic whiteboard body. Said audio expander comprises at least two audio output acoustics, implementing audio sharing.

As a further improvement of the present invention, a fingerprint identification lock for controlling the operation of master control board is mounted on said electronic whiteboard body. Said fingerprint identification lock is connected to the master control board. The additional identification function facilitates the user's control.

As a further improvement of the present invention, a short throw projector is mounted above said electronic whiteboard body. Said short throw projector is connected to the master control board. It is located above the electronic whiteboard body to solve the failure in projection resulted from an object obstructing the projection light.

As a further improvement of the present invention, said electronic whiteboard body has a layer structure, including bottom layer, intermediate layer and surface layer. Said surface layer is coated with nonreflection coating. Said intermediate layer is aluminum honeycomb structure. The nonreflection coating enables the user to see the picture clearly at any angle. The aluminum honeycomb structure guarantees the flatness of electronic whiteboard body, not to influence the signal reception of infrared camera.

Preferably, said nonreflection coating is high matte enamel coating, so that the content on the electronic whiteboard body can be seen clearly from multiple angles. The coating is very hard to prevent hard object scratching, its service life is 20 years. What is written on the coating is easy to be wiped off without trace, the convenience is enhanced greatly.

### BRIEF DESCRIPTION OF THE SEVERAL VIEWS OF THE DRAWINGS

FIG. 1 is the front view of this embodiment.

FIG. 2 is the side view with broken-out section view of this embodiment.

Where:

1-camera; 2-master control board; 3-infrared camera; 4-acoustics; 5-USB HUB multi-interface sharer; 6-fingerprint identification lock; 7-electronic whiteboard body; 71-surface layer; 72-intermediate layer; 73-bottom layer; 74-framework; 8-optical reflection strip; 9-short throw projector.

### DETAILED DESCRIPTION OF THE INVENTION

The preferred embodiment of the present invention is elaborated with attached figures below, so that the advantages and features of the present invention are easier for technical personnel of this field to comprehend, and then the scope of protection of the present invention is defined more specifically.

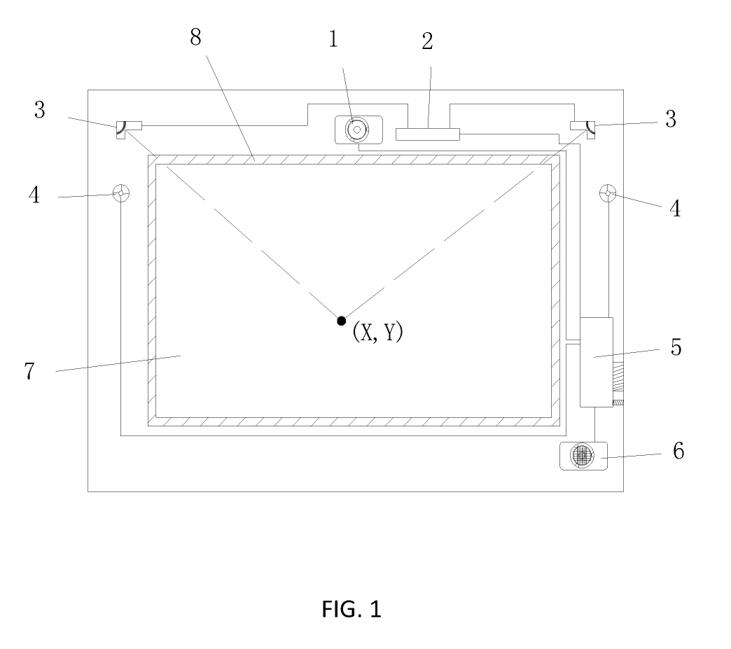

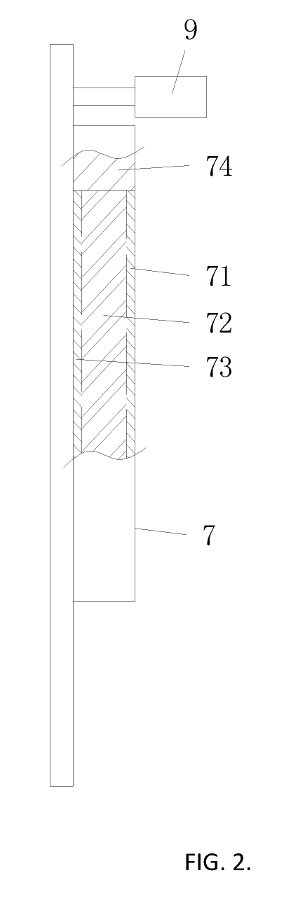

See FIGS. 1-2, an interactive electronic whiteboard with video communication function of this embodiment comprises electronic whiteboard body 7, master control board 2 embedded in framework 74 of electronic whiteboard body 7, and computer or tablet PC or mobile phone connected to electronic whiteboard body 7. the electronic whiteboard body 7 in this embodiment provides video communication, output of multiple USB transmission-based equipment via one outlet, touch control function, audio sharing, additional permission management ability, electronic whiteboard-common whiteboard switchover, the double writing on common whiteboard and electronic touch whiteboard, real-time remote video conference communication and simple data line connection are implemented. The specific structure implementing the aforesaid functions is described below:

The interactive electronic whiteboard with video communication function includes camera 1, the camera 1 is mounted in the upper frame of framework 74 of electronic whiteboard body 7. The camera 1 comprises an optical lens for image acquisition, an optical sensor for converting images into data signal and a control transmission chip for transmitting data signal to computer or tablet PC or mobile phone connected in turn. The optical sensor is connected to computer or tablet PC or mobile phone via control transmission chip. The optical lens and optical sensor record the conference scenes, which are transmitted via control transmission chip to the computer or tablet PC or mobile phone. The computer or tablet PC or mobile phone is connected to another computer or tablet PC or mobile phone via network, and the pictures are played on the electronic whiteboard body connected to another computer or tablet PC or mobile phone, so as to implement image transmission and video communication functions.

The USB HUB multi-interface sharer 5 is mounted on the framework 74 of infrared touch electronic whiteboard body 7. The USB HUB multi-interface sharer 5 is connected to master control board 2. Multiple USB transmission-based equipment implement output via one outlet of USB HUB multi-interface sharer 5, the flat cables are reduced, so that the interactive electronic whiteboard with video communication function is neat and nice. For convenient use, the USB HUB multi-interface sharer 5 is located in the lower part of one side of electronic whiteboard body 7.

The electronic whiteboard body 7 can implement touch function, because the electronic whiteboard body 7 uses infrared electronic touchpad. The electronic touch whiteboard comprises at least two infrared cameras 3 and optical reflection strip 8. At least two infrared cameras 3 are mounted in the corners of framework 74 of electronic whiteboard body 7. FIG. 1 shows two infrared cameras 3. Certainly, each corner of framework 74 can be equipped with one infrared camera 3. The optical reflection strip 8 is mounted on four edges of framework 74 of electronic whiteboard body 7. Each infrared camera 3 is embedded with a LED light source (not shown in figure). The LED light source irradiates the opposite optical reflection strip 8. The infrared camera 3 embedded with the LED light source receives the reflected light. If there is no object operated on electronic whiteboard body 7, the LED light source cannot reach the optical reflection strip 8, and then the infrared camera 3 cannot observe the reflected light. On the principle, two infrared cameras 3 transmit the observed signal to master control board 2. The master control board 2 calculates the data of touch point on optical reflection strip 8 to obtain touch coordinates (X,Y). When there are four infrared cameras 3, simultaneous touch control of more than two points can be implemented.

The electronic whiteboard body 7 can implement audio sharing, because an audio expander is embedded in the framework 74 of electronic whiteboard body 7. The audio expander comprises at least two audio output acoustics 4. As shown in FIG. 1, there are two audio output acoustics 4 on both sides of electronic whiteboard body 7.

The fingerprint identification lock 6 for controlling the operation of master control board 2 is mounted on electronic whiteboard body 7, increasing the permission management ability, the fingerprint identification lock 6 is connected to master control board 2.

The short throw projector 9 is mounted above electronic whiteboard body 7. The short throw projector 9 is connected to master control board 2.

The electronic whiteboard body 7 has a layer structure, including bottom layer 73, intermediate layer 72 and surface layer 71. When the electronic whiteboard is not used, an oil-based pen or a pen of other materials can be used to write on the surface layer 71, it acts as a common whiteboard. The surface layer 71 is provided with high matt enamel coating (vitreous enamel is also known as enamel, a sort of inorganic glass, adhering to metal surface by high temperature melting), to make sure that the content on the electronic whiteboard body 7 can be seen clearly from multiple angles. The coating is very hard, preventing it from being scratched by hard objects, its service life is 20 years. What written on the coating is easy to be wiped off without trace, the convenience is enhanced greatly. The intermediate layer 72 is aluminum honeycomb structure. As the bottom layer 73 and surface layer 71 are thin, the intermediate layer 72 uses aluminum honeycomb structure, guaranteeing the flatness of surface layer 71, the touch control will not be influenced.

Although the invention has been explained in relation to its preferred embodiment, it is to be understood that many other possible modifications and variations can be made without departing from the spirit and scope of the invention as hereinafter claimed.

I claim:

1. An interactive electronic whiteboard with video communication function includes an electronic whiteboard body, a master control board is embedded in the framework of said electronic whiteboard body, computer or tablet PC or mobile phone connected to electronic whiteboard body;
features: a camera, said camera is mounted in the upper frame of framework of electronic whiteboard body; said camera comprises an optical lens, an optical sensor and a control transmission chip connected in turn; said optical sensor is connected to computer or tablet PC or mobile phone via control transmission chip.

2. The device defined in claim 1, wherein a USB HUB multi-interface sharer is mounted on the framework of said infrared touch electronic whiteboard body said USB HUB multi-interface sharer is connected to master control board.

3. The device defined in claim 2, wherein said USB HUB multi-interface sharer is located in the lower part of one side of electronic whiteboard body.

4. The device defined in claim 1, wherein said electronic whiteboard body uses infrared electronic touchpad; said electronic touch whiteboard comprises at least two infrared cameras and optical reflection strip; said at least two infrared cameras are located in the corners of framework of electronic whiteboard body; said optical reflection strip is mounted on the four edges of framework of electronic whiteboard body; each infrared camera is embedded with a LED light source; said LED light source irradiates the opposite optical reflection strip; the infrared camera embedded with the LED light source receives the reflected light; two adjacent infrared cameras transmit the observed signal to master control board; said master control board calculates the data of touch point on optical reflection strip to obtain touch coordinates.

5. The device defined in claim 1, wherein an audio expander is embedded in the framework of said electronic whiteboard body; said audio expander comprises at least two audio output acoustics.

6. The device defined in claim 1, wherein a fingerprint identification lock for controlling the operation of master control board is mounted on said electronic whiteboard body; said fingerprint identification lock is connected to master control board.

7. The device defined in claim 1, wherein a short throw projector is mounted above said electronic whiteboard body; said short throw projector is connected to master control board.

8. The device defined in claim 1, wherein said electronic whiteboard body has a layer structure, including bottom layer, intermediate layer and surface layer; said surface layer is coated with nonreflection coating; said intermediate layer is aluminum honeycomb structure.

9. The device defined in claim 8, wherein said nonreflection coating is high matt enamel coating.
